(19) United States
(12) Patent Application Publication
(10) Pub. No.: US 2023/0120208 A1
(43) Pub. Date: Apr. 20, 2023

(54) SUGARCANE HARVESTER EXTRACTOR WITH LEAF SHREDDER

(71) Applicant: DEERE & COMPANY, MOLINE, IL (US)

(72) Inventors: MATTHEW J. HANSEN, THIBODAUX, LA (US); DUSK S. MIXON, SAINT AMANT, LA (US); JURAJ KOCIS, Slovany (SK); JAE-JAE YOUNG, THIBODAUX, LA (US); JESUS REINALDO LANDINEZ, SOUTH JORDAN, UT (US)

(21) Appl. No.: 17/451,390

(22) Filed: Oct. 19, 2021

(51) Int. Cl. A01D 45/10; A01D 43/08

(52) U.S. Cl. CPC A01D 45/10; A01D 43/08

(57) ABSTRACT

An extractor is disclosed for a sugarcane harvester that chops stalks of sugarcane into billets. The extractor comprises a fan and a leaf shredder. The fan comprises fan blades mounted for rotation about an axis of rotation to induce a flow of air to extract leaf material from billets produced by the sugarcane harvester. The leaf shredder comprises shredding knives mounted for rotation about the axis of rotation to shred leaf material prior to its ejection from the extractor. The leaf shredder is positioned below the fan or upstream from the fan relative to the flow of air.

### FIELD OF THE DISCLOSURE

The present disclosure relates to extractors for sugarcane harvesters.

### BACKGROUND OF THE DISCLOSURE

Sugarcane harvesters often have a chopper, an elevator, and one or more extractors. The chopper chops sugarcane stalks harvested by the sugarcane harvester into segments called “billets.” The elevator lifts the billets to a higher elevation for discharge into a wagon for transport to a mill. A primary extractor is located between the chopper and the elevator. In sugarcane harvesters that have a secondary extractor, the secondary extractor is mounted to the upper discharge end of the elevator. Each extractor has a fan to induce a flow of air to extract leaf material of the harvested sugarcane plants from the billets so as to clean the billets.

### SUMMARY OF THE DISCLOSURE

According to an aspect of the present disclosure, there is disclosed an extractor for a sugarcane harvester that chops stalks of sugarcane into billets. The extractor comprises a fan and a leaf shredder. The fan comprises fan blades mounted for rotation about an axis of rotation to induce a flow of air to extract leaf material from billets produced by the sugarcane harvester. The leaf shredder comprises shredding knives mounted for rotation about the axis of rotation to shred leaf material prior to its ejection from the extractor. The leaf shredder is positioned below the fan or upstream from the fan relative to the flow of air

The above and other features will become apparent from the following description and accompanying drawings.

### BRIEF DESCRIPTION OF THE DRAWINGS

The detailed description of the drawings refers to the accompanying figures in which:

FIG. 1 is a side elevational view showing a sugarcane harvester with a primary extractor;

FIG. 2 is a perspective view, with portions broken away, showing the primary extractor with a fan and a leaf shredder;

FIG. 3 is a side elevational view, with portions broken away, showing the fan and the leaf shredder;

FIG. 4 is a sectional view taken along lines 3-3 of FIG. 2, with portions broken away;

FIG. 5 is a perspective view showing fan blades mounted to an upper portion of a hub and shredding knives mounted to a lower portion of the hub;

FIG. 6 is a perspective view showing the shredding knives mounted to the lower portion of the hub;

FIG. 7 is a top plan view showing a shredding blade;

FIG. 8 is a sectional view, taken along lines 8-8 of FIG. 7, showing a cutting edge of the shredding blade; and

FIG. 9 is a side elevational view, with portions broken away, showing the leaf shredder positioned farther below the fan in a second embodiment.

### DETAILED DESCRIPTION OF THE DRAWINGS

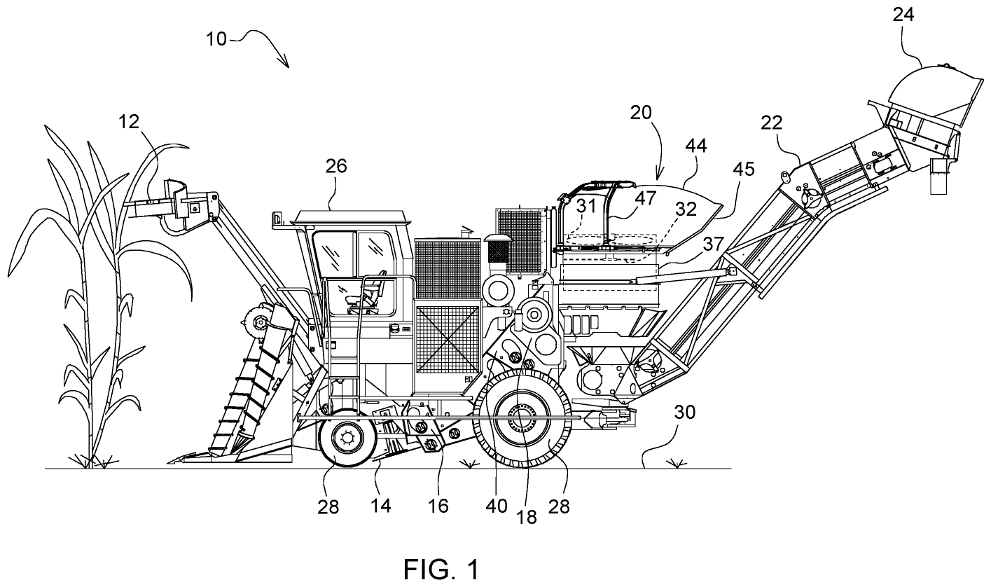

Referring to FIG. 1, a sugarcane harvester 10 is configured to harvest sugarcane. The harvester 10 includes, for example, a topper 12, one or more basecutters 14 (only one basecutter shown), a feed section 16, a chopper 18, a primary extractor 20, an elevator 22, and a secondary extractor 24. The topper 12 cuts leaf material off the top of the sugarcane plants before the plants are severed by the one or more basecutters 14, but may not remove all the leaf material from the plants before ingestion into the harvester 10. Each of the one or more basecutters 14 includes a left cutting disk and a right cutting disk (only a left cutting disk shown). The left and right cutting disks of each of the one or more basecutters 14 cooperate with one another to sever the stalks of sugarcane plants at a location near the ground. The feed section 16 receives a mat of severed sugarcane from each of the one or more basecutters 14 and feeds the one or more mats rearwardly. The chopper 18 receives the one or more mats from the feed section 16 and cuts the sugarcane stalks into billets. The primary extractor 20 is positioned between the chopper 18 and the elevator 22. The primary extractor 20 extracts leaf material ingested into the harvester 10 from the billets discharged from the chopper 18 and removes the leaf material from the harvester 10. The elevator 22 is positioned at the rear of the harvester 10 to receive the billets and convey them to an elevated position where the billets are discharged from the harvester 10 into a wagon to be hauled away. The secondary extractor 24 is mounted to the upper discharge end of the elevator 22 to further extract from the billets leaf material that may not have been removed by the primary extractor 20.

The harvester 10 includes an operator's station 26 and traction elements 28. A human operator can operate the harvester 10 from the operator's station 26. The traction elements 28 are positioned on the left and right sides of the harvester 10 for engaging the ground 30 and propelling the harvester 10 along the ground 30. Illustratively, there may be two traction elements 28, each in the form of a ground-engaging wheel, on each side of the harvester 10. In other embodiments, there may be one traction element 28, in the form of a track unit, on each side of the harvester 10

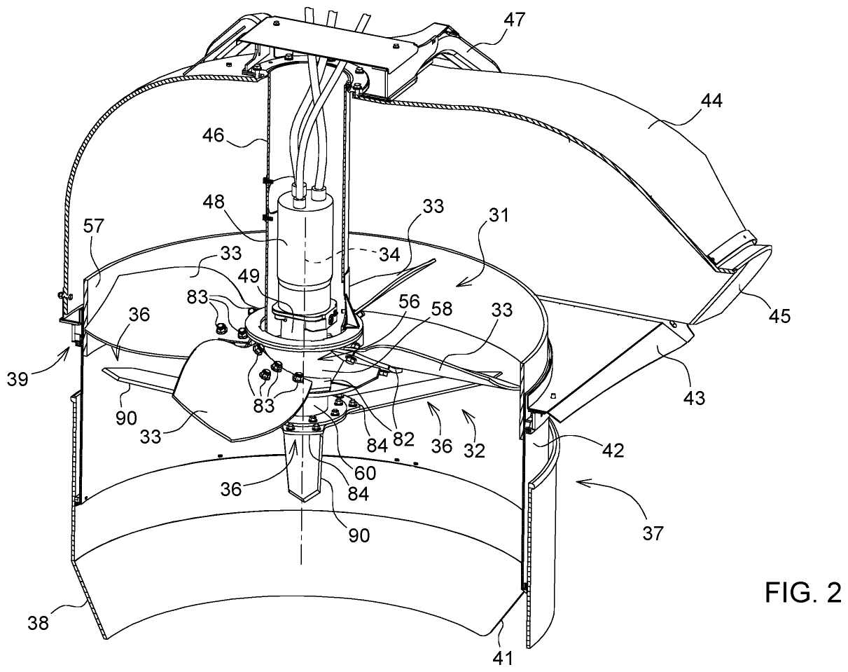

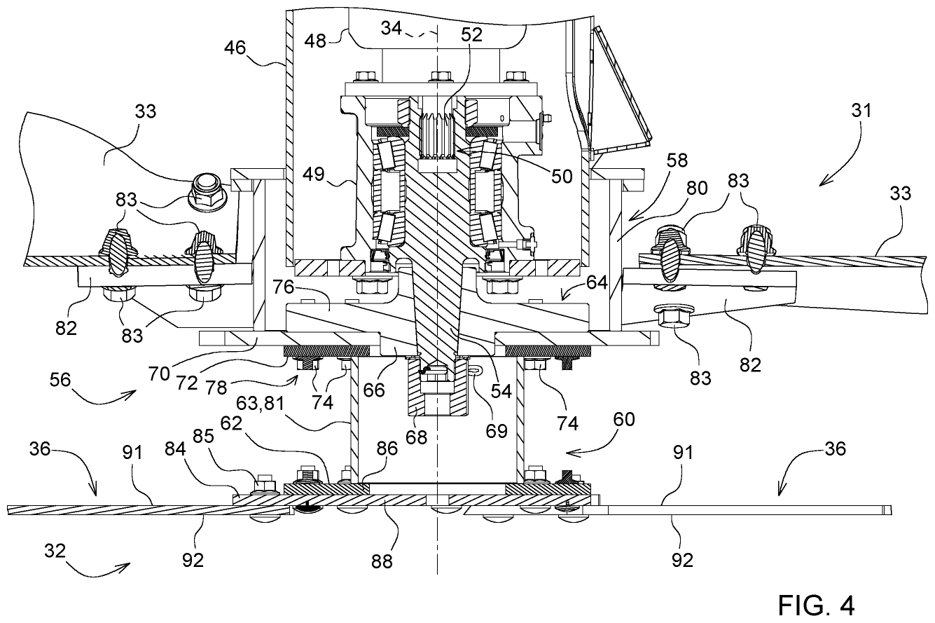

Referring to FIGS. 2-4, the extractor 20 includes a fan 31 and a leaf shredder 32. The fan 31 includes fan blades 33 (e.g., four fan blades) mounted for rotation about an axis of rotation 34 to induce a flow of air 35 to extract leaf material from billets produced by the harvester 10. The billets are discharged from the chopper 18, and are airborne upon discharge from the chopper 18, facilitating separation of leaf material from the billets by the flow of air induced by the fan 31 (billets are discharged from the elevator 22 at the secondary extractor 24, and are airborne when discharged from the elevator 22, facilitating separation of leaf material from the billets by a flow of air induced by the fan of the secondary extractor 24).

The leaf shredder 32 includes shredding knives 36 (e.g., three shredding knives) mounted for rotation about the axis of rotation 34 to shred leaf material prior to its ejection from the extractor 20. The leaf shredder 32 is positioned axially below the fan 31 so as to underlie the fan 31 relative to the axis of rotation 34 and is positioned upstream from the fan 31 relative to the flow of air 35 to promote cutting of the leaf material by the leaf shredder 32. The flow of air 35 is moving generally vertically below the fan 31, with some induced circulation closer to the fan 31. Positioning the leaf shredder 32 below the fan 31, where the flow of air 35 is more vertical, promotes relatively high velocity between the knives 36 and the flow of leaf material for cutting effectiveness of the knives 38.

The extractor housing 37 includes a lower portion 38 and an upper portion 39 supported on the lower portion 38. The lower portion 38 is fixed to a frame 40 of the harvester 10 and includes an inlet 41 of the housing 37 through which billets and leaf material enter the extractor 20 from the chopper 18. The upper portion 39 includes a conduit 42, a wear ring 57 nested at least partially in the conduit 42 and coupled thereto (e.g., welded), a frame 43 coupled to the conduit 42, and a hood 44 coupled to the frame 43. An extractor rotator can rotate the frame 43 and the hood 44 relative to the conduit 42 to redirect discharge of leaf material from a discharge outlet 45 of the hood 44 for exit of leaf material from the extractor 20 and thus the harvester 10. In some embodiments, the upper portion 39 can be raised and lowered relative to the lower portion 38, with the conduit 42 telescoping up and down relative to the lower portion 38. In other embodiments, the height of the upper portion 39 is fixed relative to the lower portion 38, although the upper portion with its frame 43 and hood 44 supported thereby can rotate relative to the lower portion 38. In such a case, the upper portion 39 may omit the conduit 42, and the wear ring 57 may instead be mounted to the conduit of the lower portion.

The upper portion 39 includes a support column 46. The support column 46 is positioned within the extractor housing 37 and is coupled to and depends from a spider 47 of the frame 43 of the upper portion 39.

The extractor 20 includes a motor 48 and a bearing assembly 49. The motor 48 and the bearing assembly 49 are positioned within and supported by the support column 46. A housing of the bearing assembly 49 is coupled (e.g., bolted) to an end cap of the support column 46. The end cap is coupled (e.g., welded) to a sleeve of the support column 46. The housing of the motor 48 is coupled (e.g., bolted) atop the housing of the bearing assembly 49.

The motor 48 includes an output 50 that rotates about the axis of rotation 34. The output 50 includes a motor shaft 52 and a shaft extension or coupling 54 splined to the motor shaft 52 and extending through the bearing assembly 49 downwardly out of the support column 46.

The shaft extension 54 is rotatably coupled to the bearing assembly 49. A nut is threaded to the shaft extension 54 near the top thereof and tightened against a hardened spacer ring so as to press the hardened spacer ring against the inner race of a double tapered bearing set of the bearing assembly 49. The outer race of the double tapered bearing set is thereby pressed against a shoulder of the housing of the bearing assembly 49.

The extractor 20 includes a hub 56 coupled to the motor 48. The hub 56 is rotatably driven about the axis of rotation 34. The motor 48 is drivingly coupled to the hub 56 via the output 50 to rotate the hub 56 and the fan 31 and leaf shredder 32 coupled thereto about the axis of rotation 34. The hub 56 receives and is coupled to the output 50 for rotation of the hub 56 therewith about the axis of rotation 34. The fan blades 33 and the shredding knives 36 are coupled to the hub 56 for rotation together with the hub 56 about the axis of rotation 34. Coupling the fan 31 and the leaf shredder 32 to the same hub 56 provides a relatively simple design for including the fan 31 and the leaf shredder 32 in the extractor 20.

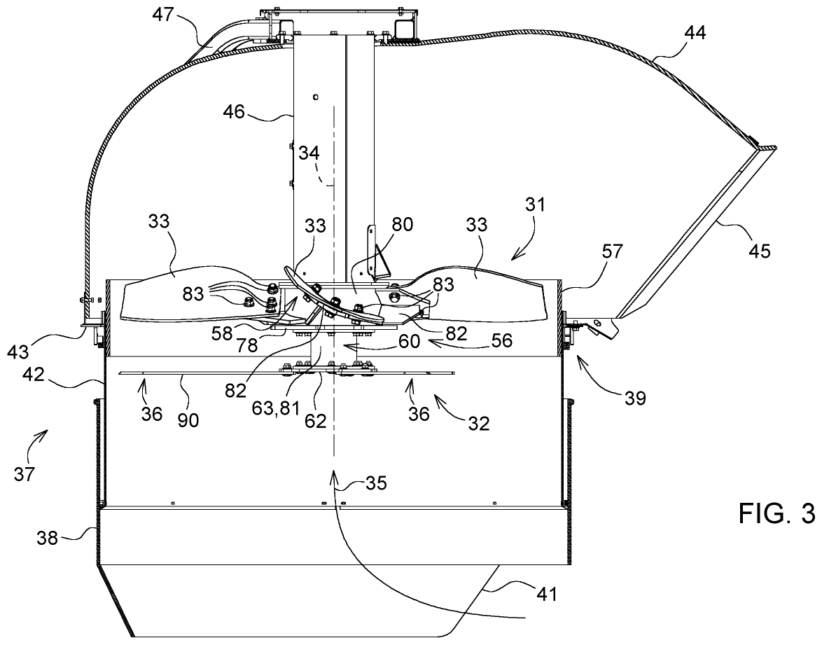

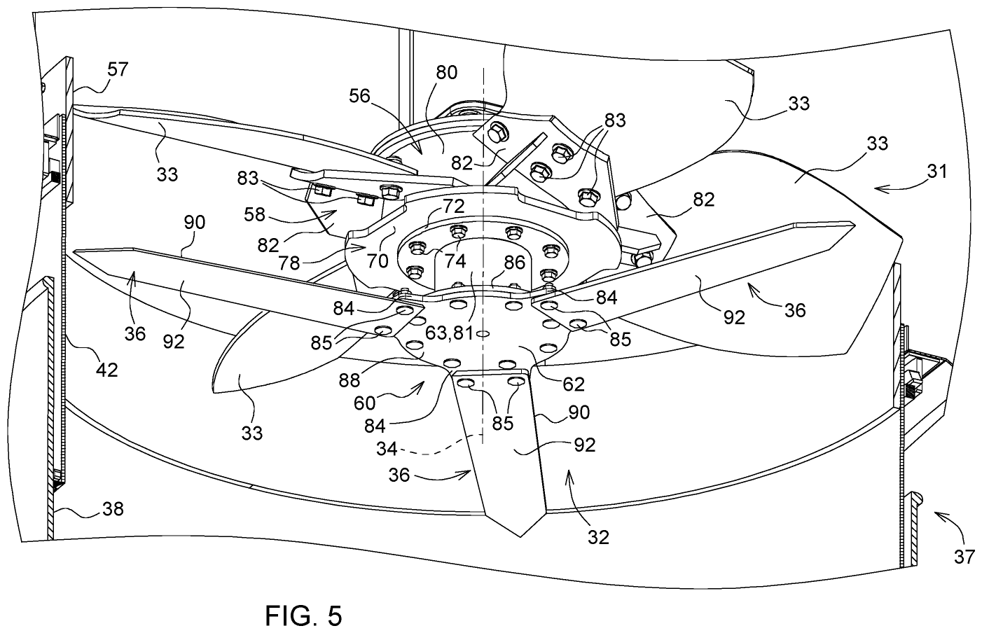

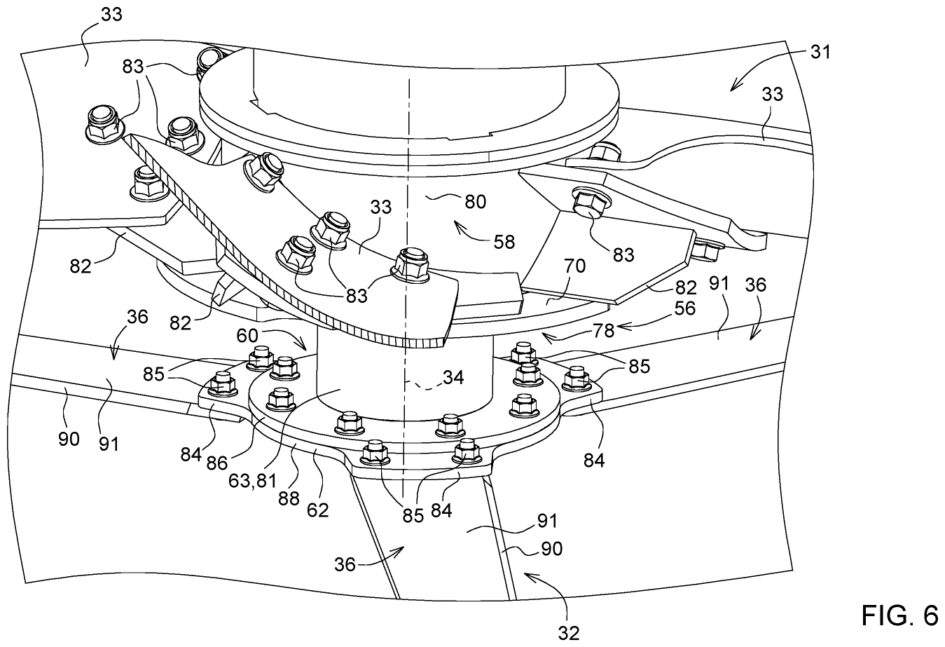

Referring to FIGS. 3-6, the hub 56 includes an upper portion 58 and a lower portion 60 extending downwardly from the upper portion 58. The fan blades 33 are mounted to the upper portion 58, and the shredding knives 36 are mounted to the lower portion 60. The shredding knives 36 are mounted to a bottom end portion 62 of the lower portion 60. A neckdown portion 63 of the lower portion 60 is positioned between the upper portion 58 and the bottom end portion 62 and is narrower in diameter than the upper portion 58.

The upper portion 58 includes a central support 64. The central support 64 receives and is coupled to the shaft extension 54 of the output 50 for rotation of the central support 64 therewith about the axis of rotation 34. A sleeve 66 of the central support 64 includes a tapered hole that receives and mates with a tapered portion of the shaft extension 54. The sleeve 66 and the shaft extension 54 are keyed to one another against rotation therebetween. A nut 68 is threaded onto the tapered portion of the shaft extension 54 with a cotter pin 69 passing through corresponding holes formed in the nut 68 and an end portion of the shaft extension 54, fixing the central support 64 of the hub 56 to the shaft extension 54 for rotation therewith about the axis of rotation 34. The hub 56 may be coupled to the shaft extension 54 in a wide variety of ways.

The upper portion 58 includes a support plate 70, a clamping plate 72, and fasteners 74 (e.g., eight fasteners). An annular flange 76 of the central support 64 surrounds and extends radially outwardly from the sleeve 66 of the central support 64. The support plate 70 is sandwiched between the flange 76 of the central support 64 and the clamping plate 72, with the fasteners 74 extending through the clamping plate 72 and the support plate 70 into the flange 76 to mount the support plate 70 and the clamping plate 72 to the central support 64 for rotation therewith about axis of rotation 34. The central support 64, the support plate 70, the clamping plate 72, and the fasteners 74 cooperate to provide an intermediate wall 78 of the hub 56.

The upper portion 58 includes an upper sleeve 80, and the lower portion 60 includes a lower sleeve 81 as the neckdown portion 63. The intermediate wall positioned 78 is positioned axially below the support column 46 relative to the axis of rotation 34 and between the upper sleeve 80 and the lower sleeve 81. The upper sleeve 80 extends upwardly from the intermediate wall 78 and surrounds the support column 46. The upper sleeve 80 is coupled to the support plate 70 (e.g., welded) so as to extend upwardly therefrom. The lower sleeve 81 extends downwardly from the intermediate wall 78. The lower sleeve 81 is coupled to the clamping plate 72 (e.g., welded) so as to extend downwardly therefrom.

The fan 31 is coupled to the upper portion 58 of the hub 56 to rotate therewith about the axis of rotation 34. The fan blades 33 are coupled to the upper sleeve 80 of the upper portion 58 thereabout via a first set of attachment points 82 included in the upper portion 58. The fan blades 33 are coupled respectively to the attachment points 82 with fasteners 83 (e.g., bolts). For example, each fan blade 33 is coupled to the respective attachment point 82 with four fasteners 83.

Each of the attachment points 82 includes a mounting plate fixedly coupled to the upper sleeve 80 (e.g., welded) and a reinforcement plate fixedly coupled to the upper sleeve 80 (e.g., welded) and to an underside of the mounting plate of the attachment point 82 (e.g., welded) to reinforce the mounting plate of the attachment point 82. Each fan blade 33 is coupled to a mounting plate of a respective attachment point 82 with fasteners 83. The fan blades 33 may be coupled to the upper portion 58 of the hub 56 in a wide variety of ways.

The leaf shredder 32 is coupled to the lower portion 60 of the hub 56 to rotate therewith about the axis of rotation 34. The leaf shredder 32 is positioned below the support column 46. The shredding knives 36 are coupled to the lower sleeve 81 of the lower portion 60 thereabout via a second set of attachment points 84 included in the lower portion 60. The shredding knives 36 are coupled respectively to the attachment points 84 with fasteners 85 (e.g., bolts). For example, each shredding knife 36 is coupled to the respective attachment point 84 with two fasteners 85. The second set of attachment points 84 is positioned axially below and axially upstream from the first set of attachment points 82 relative to the axis of rotation 34. As such, the leaf shredder 32 and its shredding knives 36 are positioned axially below and axially upstream from the fan 31 and its fan blades 33 relative to the axis of rotation 34. The leaf shredder 32 and its shredding knives 36 are positioned fluidly between the inlet 41 and the fan 31 and its fan blades 33 relative to the flow of air 35.

The bottom end portion 62 of the lower portion 60 includes a support plate 86 and a mounting plate 88. The support plate 86 is coupled to a bottom edge of the lower sleeve 81 (e.g., welded). The mounting plate 88 is coupled to the support plate (e.g., bolted with eight bolts). The mounting plate 88 includes the second set of attachment points 84. Each attachment point 84 is configured, for example, as a tab projecting radially relative to the axis of rotation 34 and included in the mounting plate 88. Each shredding knife 36 is coupled to a respective tab with two fasteners 85. The shredding knives 36 may be coupled to the lower portion 60 of the hub 56 in a wide variety of ways.

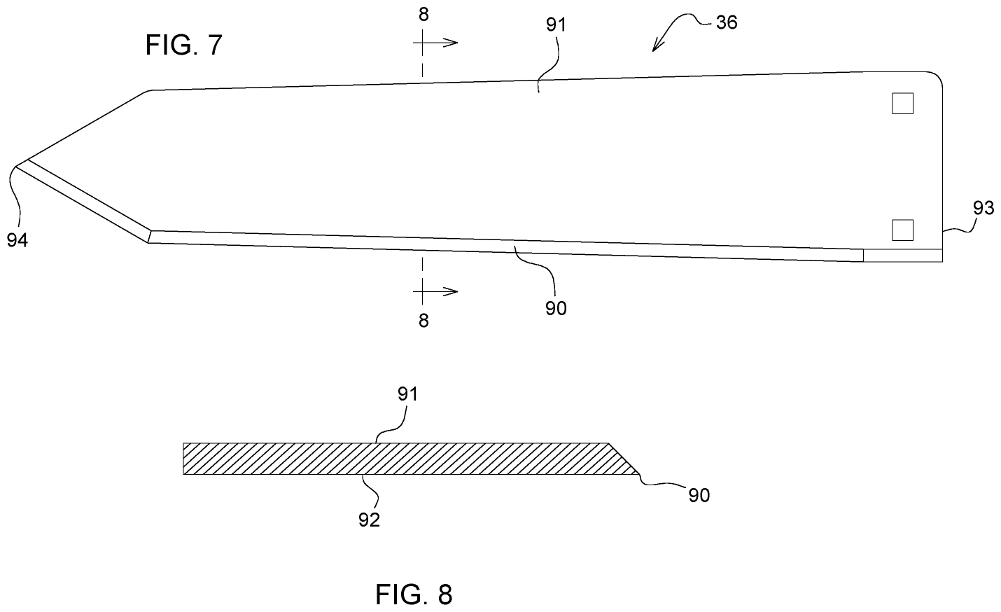

Referring to FIGS. 7 and 8, each shredding knife 36 includes a sharpened cutting edge 90. The cutting edge 90 is the leading edge of the knife 36 in the direction of rotation of the leaf shredder 32 about the axis of rotation 34. The cutting edge 90 is formed as a bevel extending between and connecting an upper surface 91 of the shredding knife 36 and a lower surface 92 of the shredding knife 36. In some embodiments, the cutting edge may be formed by an upper bevel and a lower bevel extending respectively from the upper surface 91 and the lower surface 92 so as to intersect one another. Illustratively, the cutting edge 90 extends the entire length of the knife 36, from a radially innermost extent 93 of the knife 36 to a radially outermost extent 94 of the knife 36 relative to the axis of rotation 34, to promote the cutting capacity of the knife 36.

Referring back to FIGS. 2-6, the fan blades 33 and the shredding knives 36 can be replaced. The fan blades 33 and the shredding knives 36 are removably coupled to the hub 56. Each fan blade 33 is removably coupled to the respective attachment point 82 of the hub 56 with fasteners 83. A worn or damaged fan blade 33 can be removed from the attachment point 82 upon removal of the fasteners 83, and a fresh fan blade 33 can be coupled to the attachment point 82 in place of the worn or damaged fan blade 33 upon reattachment of the fasteners 83. Similarly, each shredding knife 36 is removably coupled to the respective attachment point 84 of the hub 56 with fasteners 85. A worn or damaged shredding knife 36 can be removed from the attachment point 84 upon removal of the fasteners 85, and a fresh shredding knife 36 can be coupled to the attachment point 84 in place of the worn or damaged shredding knife 36 upon reattachment of the fasteners 85.

The leaf shredder 32 is positioned upstream from the fan 31 to shred leaf material. Upstream in the illustrated embodiment is below the fan 31 in a relatively compact configuration of the extractor 20. In other embodiments, the leaf shredder 32 may be to the side or possibly above the fan 31 in an upstream arrangement. In any case, the leaf shredder 32 is positioned upstream in the flow of air 35 where the differential velocity between the rotating fan blades 33 and the flow of air 35 promotes the cutting effectiveness of the knives 38 for shredding of leaf material. As such, the length of the sleeve 81 may be shorter or longer depending on the characteristics of the flow of air 35.

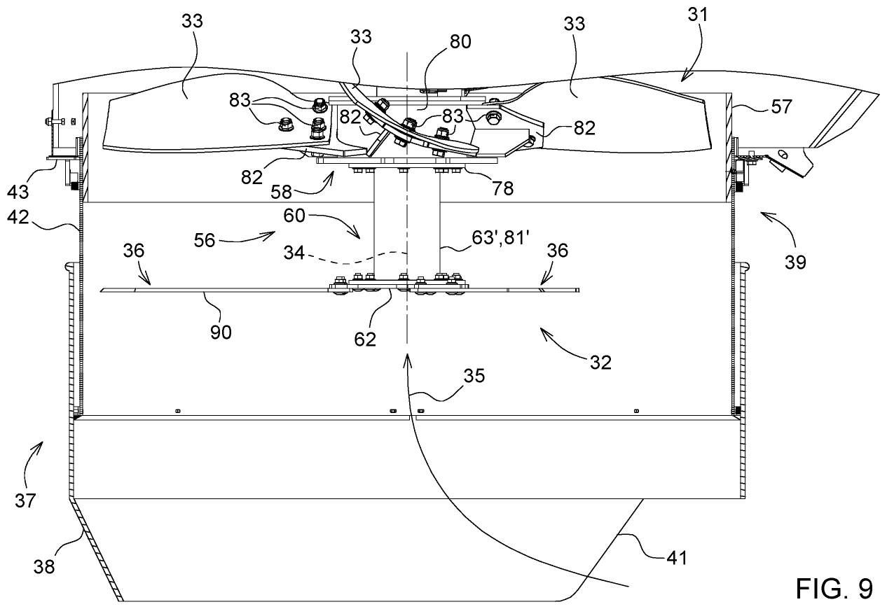

Referring to FIG. 9, the extractor 20 is modified to include a longer sleeve 81′ as the neckdown portion 63′ of the lower portion 60. The leaf shredder 32 is thereby positioned further upstream in the flow of air 35 from the fan 31 and further below the fan 31.

It is to be understood that the fan 31 may include any suitable number of fan blades 33, and the leaf shredder 32 may include any suitable number of shredding knives 36. The shredding knives 36 may be arranged in any suitable angular arrangement about the axis of rotation 34 relative to the fan blades 33.

Threads and welds are not shown for ease of illustration. However, it is to be appreciated that bolts, nuts, and corresponding mating surfaces would have threads.

While the above describes example embodiments of the present disclosure, these descriptions should not be viewed in a limiting sense. Rather, other variations and modifications can be made without departing from the scope and spirit of the present disclosure as defined in the appended claims.

What is claimed is:

1. An extractor for a sugarcane harvester that chops stalks of sugarcane into billets, the extractor comprising:
a fan comprising fan blades mounted for rotation about an axis of rotation to induce a flow of air to extract leaf material from billets produced by the sugarcane harvester, and
a leaf shredder comprising shredding knives mounted for rotation about the axis of rotation to shred leaf material prior to its ejection from the extractor, the leaf shredder positioned below the fan or upstream from the fan relative to the flow of air.

2. The extractor of claim 1, wherein the leaf shredder is positioned below the fan.

3. The extractor of claim 2, wherein the leaf shredder is positioned upstream from the fan relative to the flow of air.

4. The extractor of claim 1, wherein the leaf shredder is positioned upstream from the fan relative to the flow of air.

5. The extractor of claim 1, comprising an extractor housing, wherein the fan and the leaf shredder are positioned within the extractor housing.

6. The extractor of claim 1, comprising a hub rotatably driven about the axis of rotation, wherein the fan blades and the shredding knives are coupled to the hub for rotation together with the hub about the axis of rotation.

7. The extractor of claim 6, comprising a motor drivingly coupled to the hub to rotate the hub and the fan and leaf shredder coupled thereto about the axis of rotation.

8. The extractor of claim 7, comprising an extractor housing and a support column, wherein the fan, the leaf shredder, and the support column are positioned within the extractor housing, the motor is positioned within and supported by the support column, and the leaf shredder is positioned below the support column.

9. The extractor of claim 8, wherein the hub comprises an upper sleeve, a lower sleeve, and an intermediate wall positioned below the support column and between the upper sleeve and the lower sleeve and from which the upper sleeve extends upwardly and the lower sleeve extends downwardly, the upper sleeve surrounds the support column, the fan blades are coupled to the upper sleeve thereabout, and the shredding knives are coupled to the lower sleeve thereabout.

10. The extractor of claim 6, wherein the hub comprises an upper portion and a lower portion extending downwardly from the upper portion, the fan blades are mounted to the upper portion, and the shredding knives are mounted to the lower portion.

11. The extractor of claim 10, wherein the lower portion of the hub comprises a bottom end portion, and the shredding knives are mounted to the bottom end portion.

12. The extractor of claim 11, wherein the lower portion comprises a neckdown portion that is positioned between the upper portion and the bottom end portion and is narrower in diameter than the upper portion.

13. The extractor of claim 6, wherein the hub comprises a first set of attachment points to which the fan blades are coupled and a second set of attachment points to which the shredding knives are coupled, and the second set of attachment points is positioned axially below the first set of attachment points relative to the axis of rotation.

14. The extractor of claim 6, wherein the shredding knives are removably coupled to the hub.

15. The extractor of claim 1, wherein each shredding knife includes a cutting edge.

16. The extractor of claim 15, wherein the cutting edge of each shredding knife extends an entire length of the shredding knife.

17. The extractor of claim 1, comprising an inlet, wherein the leaf shredder is positioned fluidly between the inlet and the fan relative to the flow of air.

17. A sugarcane harvester comprising the extractor of claim 1.
